(19) United States
(12) Patent Application Publication
(10) Pub. No.: US 2013/0029021 A1
(43) Pub. Date: Jan. 31, 2013

(54) Extending Filter Basket

(71) Applicant: Green Planet Solutions, LLC, Highlandville, MO (US)

(72) Inventors: Charles Ketter, JR., Greenwood, AR (US); Mark Mathes, Highlandville, MO (US)

(73) Assignee: GREEN PLANET SOLUTIONS, LLC, Highlandville, MO (US)

(21) Appl. No.: 13/632,930

(22) Filed: Oct. 1, 2012

Related U.S. Application Data
(63) Continuation-in-part of application No. 12/467,514, filed on May 18, 2009, now Pat. No. 8,307,759.
(60) Provisional application No. 61/055,495, filed on May 23, 2008.

(51) Int. Cl. A47J 37/12; A23L 1/01

(52) U.S. Cl. 426/438; 99/403

(57) ABSTRACT

A mesh filter basket comprising a frame, and a wire mesh attached to the frame, wherein the mesh filter basket is configured to be placed inside a fryer comprising cooking liquid, wherein the mesh filter basket is configured to receive a fryer basket comprising food, wherein the mesh filter basket is configured to allow the cooking liquid to pass through the mesh and cook the food in the fryer basket, and wherein the mesh filter basket is configured to retain food particles escaping the fryer basket.

### CROSS-REFERENCE TO RELATED APPLICATIONS

This application is a continuation in part of prior U.S. patent application Ser. No. 12/467,514, filed on May 18, 2009, which claims priority to U.S. Provisional Patent Application No. 61/055,495 filed on May 23, 2008, both of which are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Restaurants may employ fryers to cook fried foods. Cooking liquid (e.g. cooking oil, water, etc.) may be poured into a fryer and heated. The food that is to be cooked (e.g. fried) may be battered and placed in a basket. The basket may then be lowered into the fryer. The basket may be constructed to allow the heated cooking liquid to come into contact with the food. The heat from the cooking liquid may cause the food to cook. The basket containing the food may then be removed from the fryer, which may allow the heated cooking liquid to drain back into the fryer.

Foods that are cooked by frying may be covered in one or more coatings such as flour, egg, breading, seasoning, and other coatings prior to being placed in the heated cooking liquid. The coatings and particles of the food may become dislodged from the food during the frying process and drain into the fryer along with the cooking liquid. The food particles may remain in the cooking liquid over repeated cooking cycles, may become carbonized, and may negatively affect the flavor of foods cooked during a subsequent cooking cycle. The buildup of such food particles may result in cooking liquid that is unusable for cooking and must be changed after a few frying cycles.

### SUMMARY

In one embodiment, the disclosure includes a mesh filter basket comprising a frame, and a wire mesh attached to the frame, wherein the mesh filter basket is configured to be placed inside a fryer comprising cooking liquid, wherein the mesh filter basket is configured to receive a fryer basket comprising food, wherein the mesh filter basket is configured to allow the cooking liquid to pass through the mesh and cook the food in the fryer basket, and wherein the mesh filter basket is configured to retain food particles escaping the fryer basket.

In another embodiment, the disclosure includes a method comprising, placing a mesh filter basket into a fryer comprising cooking liquid, causing the fryer to heat the cooking liquid, placing a fryer basket comprising uncooked food into the mesh filter basket, retaining the fryer basket in the mesh filter basket until the food is cooked, and removing the fryer basket and the cooked food, wherein the mesh filter basket comprises, a frame, and a wire mesh attached to the frame, wherein the mesh filter basket is configured to allow the cooking liquid to enter the mesh filter basket via the wire mesh, and wherein the mesh filter basket is configured to retain food particles that escape the fryer basket via the wire mesh.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a general perspective view of an embodiment of a mesh filter basket.

FIG. 2 is a general perspective view of a second embodiment of a mesh filter basket.

FIG. 3 is a general perspective view of a third embodiment of a mesh filter basket.

FIG. 4 is a general perspective view of a fourth embodiment of a mesh filter basket.

FIG. 5 is a top plan view of the components of a fifth embodiment a mesh filter basket.

FIG. 6 is a general perspective view of the fifth embodiment of a mesh filter basket.

FIG. 7 is a general perspective view of a sixth embodiment of a mesh filter basket.

FIG. 8 is a general perspective view of a portion of the sixth embodiment of a mesh filter basket.

FIG. 9 is a general perspective view of the sixth embodiment of a mesh filter basket being placed in a fryer.

FIG. 10 is a general perspective view of an embodiment of a fryer basket placed inside a fryer comprising the sixth embodiment of a mesh filter basket.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a mesh filter basket that may act as a filter between a fryer basket and heated cooking liquid. The mesh filter basket may comprise a wire mesh having holes that may be small enough to trap most food particles and large enough to allow heated cooking liquid to pass through the mesh quickly and without causing bubbling. The wire mesh may comprise various ranges of distances between adjacent parallel wires, for example from about 0.0010 to about 0.0450 inches, from about 0.0060 to about 0.0350, or from about 0.0060 to about 0.0150 inches. The mesh filter basket may be placed in a fryer prior to a cooking session. The user may then place a fryer basket containing food inside the mesh filter basket, cook the food, and remove the fryer basket. The mesh filter basket may be removed from the fryer and drained of cooking liquid. Food particles from the fryer basket may be retained by the mesh filter basket and disposed of, which may extend the useful life of the cooking liquid.

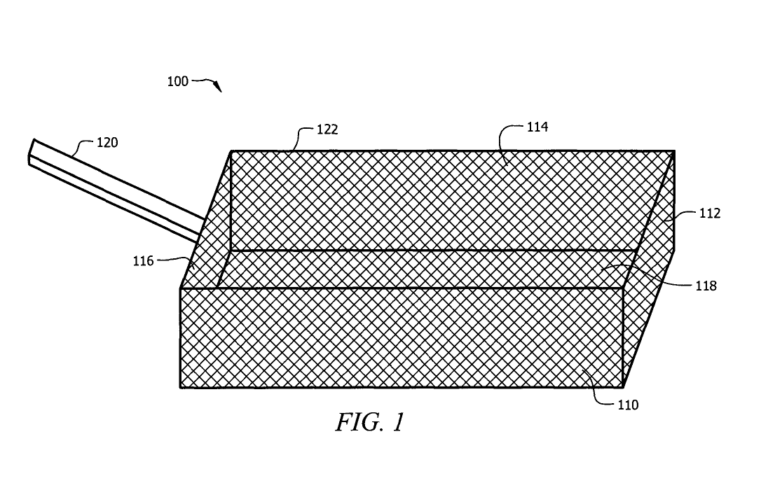

FIG. 1 is a general perspective view of an embodiment of a mesh filter basket 100. The mesh filter basket 100 may be generally rectangular and may comprise a frame 122 with longitudinal mesh side walls 110 and 114, latitudinal mesh side walls 112 and 116, a mesh base 118, and a handle 120. Frame 122 may be constructed of substantially rigid stainless steel, electro-polished stainless steel, sheet metal, copper, or other materials that maintain a substantially rigid structure at temperatures commonly used for frying (e.g. less than 500 degrees Fahrenheit). The frame 122 may be constructed in the form of thick wire, sheet metal, solid bars, hollow bars, hollow tubes, etc. Handle 120 may be detachable from the mesh filter basket 100 and may comprise metal, silicone, heat insulators, and/or other materials. The mesh base 118 may comprise adjacent parallel wires with various ranges of distances between them, for example from about 0.0010 inches to about 0.0450 inches, from about 0.0060 inches to about 0.0350 inches, or from about 0.0060 inches to about 0.0150 inches. The distance between the adjacent parallel wires may be measured from the center of a first wire to the center of a second wire. In an embodiment, the mesh base 118 may comprise wires with a diameter of 0.014 inches. In an embodiment, the mesh base 118 may comprise twenty four openings per square inch, and may be referred to as size 24 mesh.

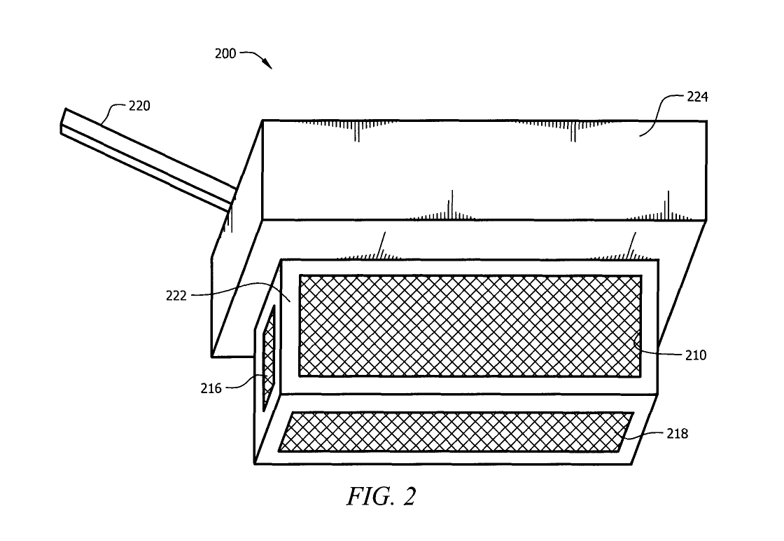

FIG. 2 is a general perspective view of a second embodiment of a mesh filter basket 200. The mesh filter basket 200 may be generally rectangular and may comprise an upper frame 224, a lower frame 222 comprising lower longitudinal mesh side walls 210 and lower latitudinal mesh side walls 216, a mesh base 218, and a handle 220. The upper frame 224 and the lower frame 222 may be constructed of substantially rigid stainless steel, sheet metal, copper, or other materials that maintain a substantially rigid structure at temperatures commonly used for frying (e.g. less than about 500 degrees Fahrenheit). The upper frame 224 may be connected to the lower frame 222 and the handle 220 as shown in FIG. 2. The lower frame 222 may be connected to and provide support to the mesh side walls 216 and mesh base 218. The mesh side walls 216, mesh base 218, and handle 220 may be substantially similar to mesh side walls 112, mesh base 118, and handle 120, respectively.

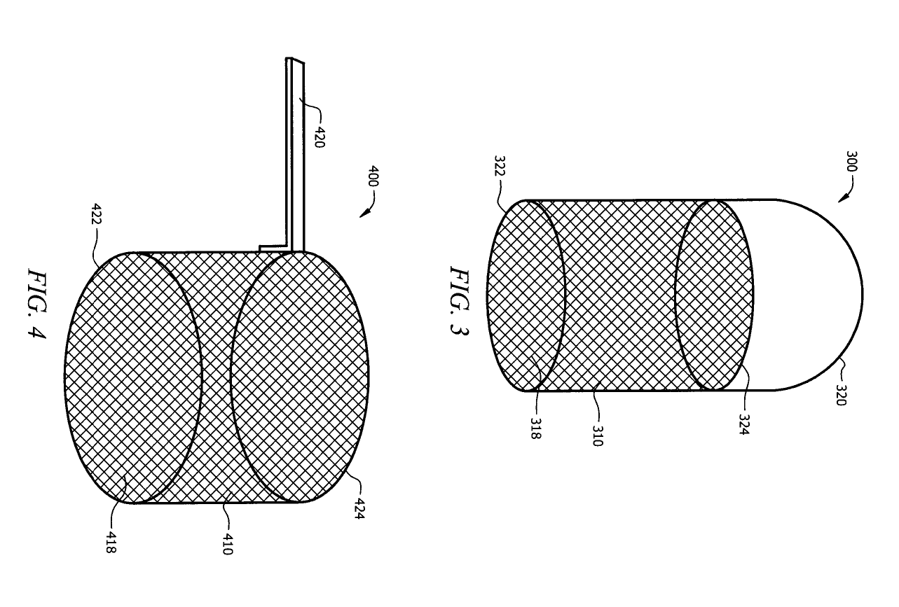

FIG. 3 is a general perspective view of a third embodiment of a mesh filter basket 300. The mesh filter basket 300 may be generally cylindrical and may comprise an upper frame 324, a lower frame 322, mesh base 318, a mesh side wall 310, and a handle 320. The upper frame 324 may comprise a substantially circular shape and may be connected to the mesh side wall 310. The mesh side wall 310 may be substantially cylindrical and may be connected to the lower frame 322. The lower frame 322 may be substantially circular. The handle 320 may comprise a semicircular shape and may be connected to the upper frame 324 in at least two locations as shown in FIG. 3. The components of mesh filter basket 300 comprise similar materials of analogous components in mesh filter baskets 100 and/or 200.

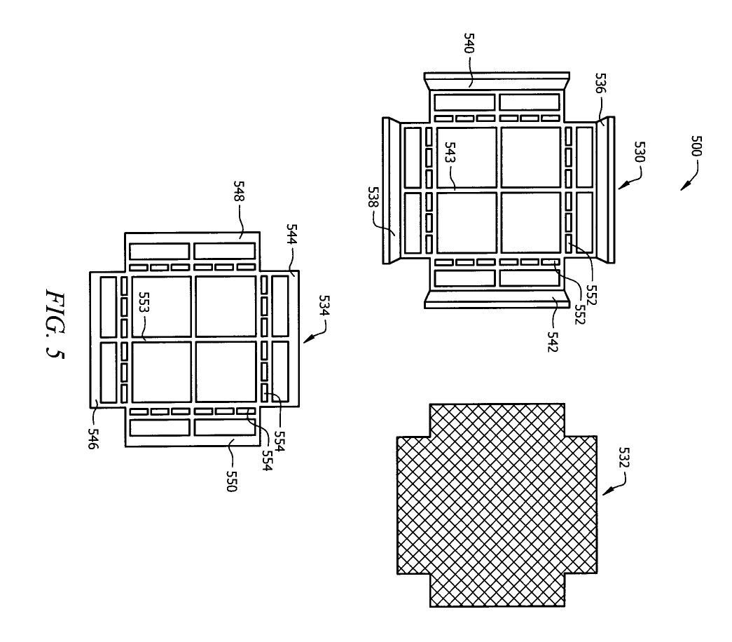

FIG. 4 is a general perspective view of a fourth embodiment of a mesh filter basket 400. Mesh filter basket 400 may be generally cylindrical and may comprise an upper frame 424, a lower frame 422, a mesh base 418, a mesh side wall 410, and a handle 420, which may be substantially similar to upper frame 324, lower frame 322, mesh base 318, mesh side wall 310, and a handle 320, respectively. Handle 420 may be comprise a rigid material and may extend longitudinally from upper frame 424. The components of mesh filter basket 400 may comprise similar materials of analogous components in mesh filter baskets 100, 200, and/or 300.

FIG. 5 is a top plan view of the components 500 of a fifth embodiment a mesh filter basket. The components of mesh filter basket 500 are shown in a disassembled view. The mesh filter basket 500 may comprise from an outer frame 530, a precut piece of mesh 532 and an inner frame 534. The components of mesh filter basket 500 may comprise similar materials of analogous components in mesh filter baskets 100, 200, 300, and/or 400. Outer frame 530 may comprise latitudinal outer frame side walls 536 and 538, longitudinal outer frame side walls 540 and 542, and outer frame base 543. Inner frame 534 may comprise latitudinal inner frame side walls 544 and 546, longitudinal inner frame side walls 548 and 550, and inner frame base 553. Outer frame 530 and inner frame 534 may comprise a plurality of corresponding boiling slots 552 and 554 respectively. Boiling slots 552 and 554 may aid in frying by allowing gases created during frying to evenly escape.

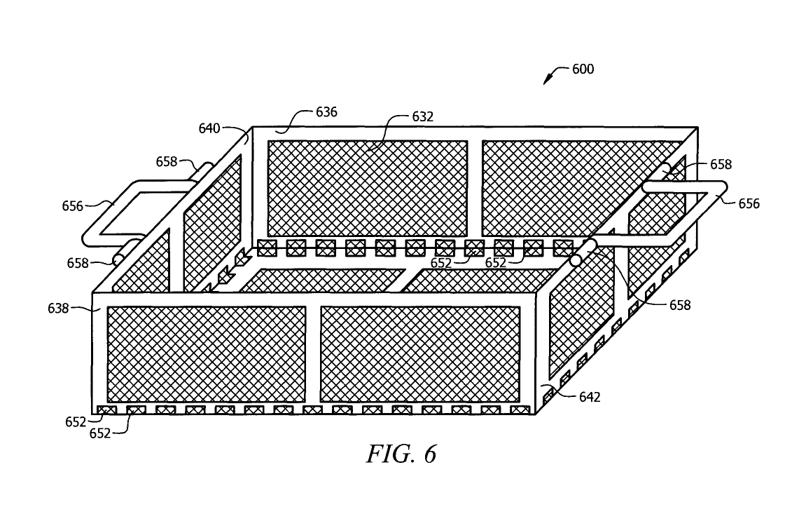

The mesh filter basket 500 may be assembled by placing mesh 532 into outer frame 530, then placing inner frame 534 on top of mesh 532, so that the side walls of the inner frame 534 are located directly above the side walls of the outer frame 530, e.g. side wall 544 above side wall 536, side wall 550 above side wall 542, side wall 546 above side wall 538, and side wall 548 above side wall 540. The side walls of the inner frame 534 the side walls of the outer frame 530 may then be folded vertically into a rectangular shape resulting in mesh filter basket 600 as shown in FIG. 6. In addition or in the alternative, mesh filter basket 600 may be assembled by folding side walls of outer framer 530 and inner framer 534 vertically. Then mesh 532 may be placed into outer frame 530 and secured to inner frame 534 so that mesh 532 is sandwiched between outer frame 530 and inner frame 532. The basket components 530, 532, and 534 may be secured together by any means known in the art, for example welding, screws, nuts, bolts, clips, rivets, fasteners, or the like. The basket components 530, 532, and 534 may be secured together in a temporary fashion to allow for easy replacement of the mesh 532. The basket components 530, 532, and 534 may be secured together by intimate contact, such that when inner frame 534 is pushed into outer frame 530 with mesh 532 sandwiched between the two frames, the outer frame 530 and inner frame 534 snap together and form a secure and sturdy basket that can later be disassembled for easy replacement of the mesh 532.

FIG. 6 is a general perspective view of the fifth embodiment of a mesh filter basket 600. Mesh filter basket 600 may result when basket components 530, 532, and 534 are assembled as discussed above. Mesh 632, side wall 636, side wall 638, side wall 640, side wall 642, and boiling slots 652 may correspond to and/or be substantially similar to mesh 532, side wall 536, side wall 538, side wall 540, side wall 542, and boiling slots 552, respectively. The mesh filter basket 600 may also comprise detachable handles 656, which may be connect to outer frame 530 by brackets 658 or any other detachable and reattachable connectors.

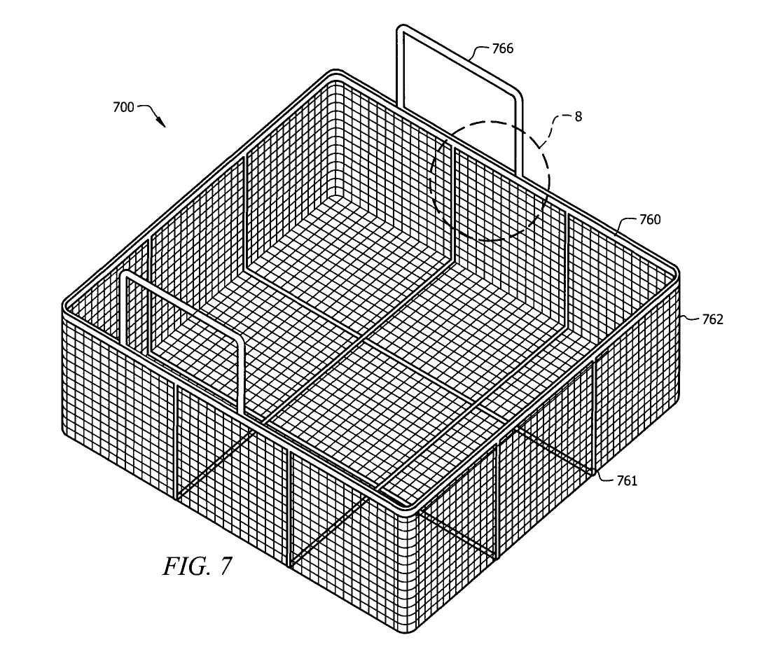

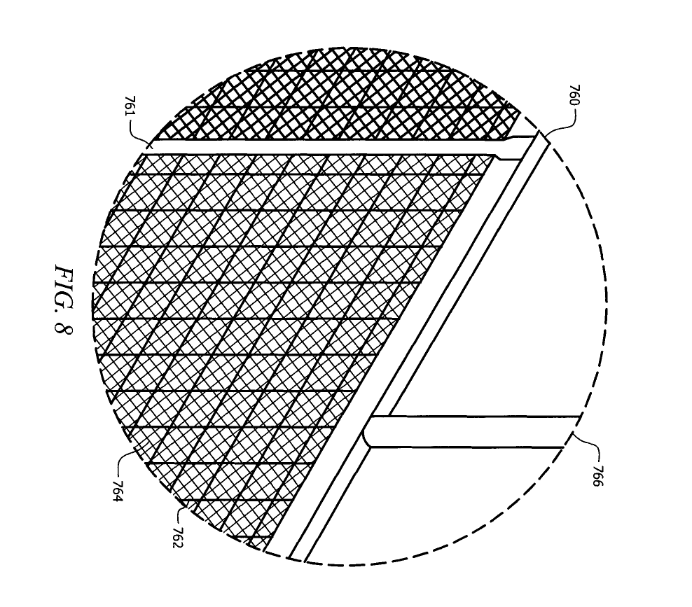

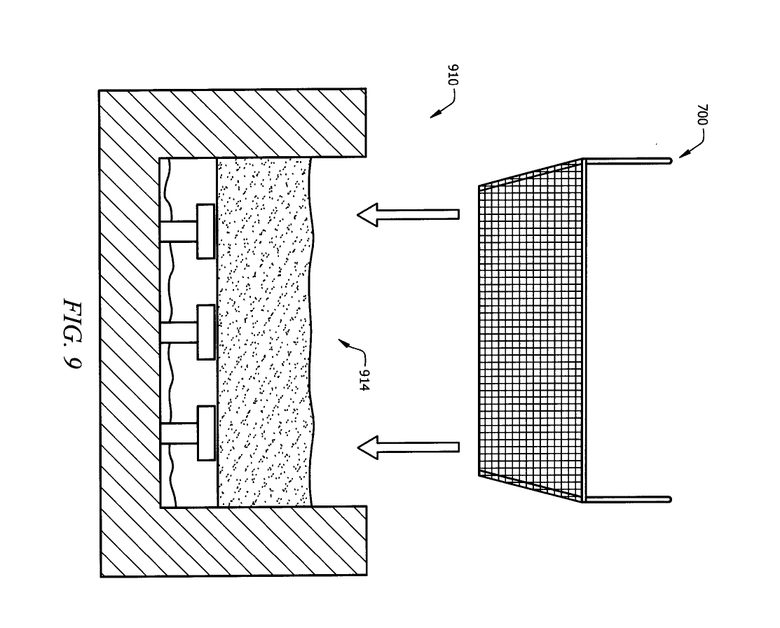

FIG. 7 is a general perspective view of a sixth embodiment of a mesh filter basket 700. Mesh filter basket 700 may comprise a frame 760, a structural mesh 762, handles 766, and filter mesh 764 (shown in FIG. 8). The components of mesh filter basket 700 may comprise similar materials of analogous components in mesh filter baskets 100, 200, 300, 400, and/or 500. The frame 760 may be attached to the handles 766 as shown in FIG. 7. The frame 760 may comprise a rectangular shape as shown in FIG. 7, or may comprise any shape that fits into a fryer. The frame 760 may comprise support members 761 that form the general shape of and provide support for mesh filter basket 700. The support members 761 may comprise wires with a diameter of about 0.125 inches positioned so that the distance between adjacent parallel wires is about three inches. Briefly referencing FIG. 8, which is a general perspective view of a portion of the sixth embodiment of a mesh filter basket 700, the filter mesh 764 may be attached to the frame 760 and/or the support members 761. The filter mesh 764 may be substantially similar to the mesh of mesh filter baskets 100-600, and may retain and/or filter food particles out of cooking liquid. The structural mesh 762 may be attached to the frame 760, the support members 761, and or the filter mesh 764. The structural mesh 762 may be positioned to form an outer surface of the mesh filter basket 700. The structural mesh 762 may be sized to allow cooking liquid to freely pass into and out of the mesh filter basket 700 while providing protection for the filter mesh 764 during use. For example, the structural mesh 762 may comprise wires with various ranges of distances between adjacent parallel wires, for example from about 0.5 inches to about 1.5 inches, from about 0.5 to about 1 inch, or from about 1 inch to about 1.5 inches. For example, the structural mesh 762 may comprise 0.92 inches between adjacent parallel wires, 1 opening per square inch, and may be referred to as 1 by 1 mesh. In an embodiment, the structural mesh 762 may comprise stainless steel (e.g. type 304 stainless steel). The structural mesh 762 wires may comprise diameters ranging from about 0.12 inches to about 0.08 inches, from about 0.08 inches to about 0.04 inches, or from about 0.12 inches to about 0.04 inches. The distance between the adjacent parallel wires may be measured from the center of a first wire to the center of a second wire. The larger opening sizes of the structural mesh 762 may reduce the occurrence of food particles becoming stuck between the structural mesh 762 and the filter mesh 764.

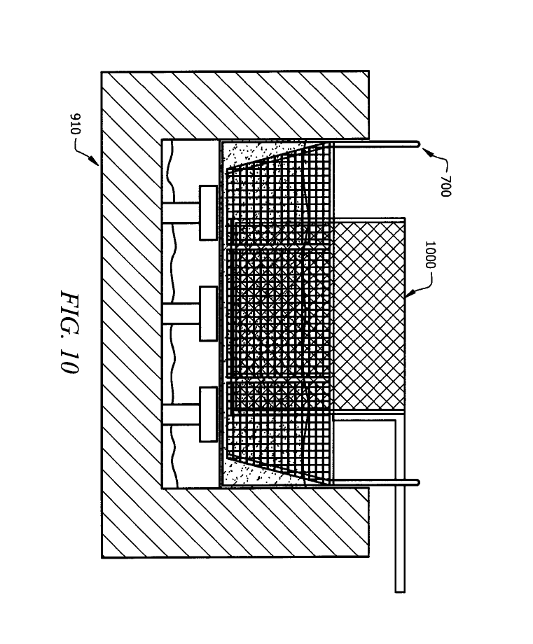

FIG. 9 is a general perspective view of the sixth embodiment of a mesh filter basket 700 being placed in a fryer 910. The fryer 910 may comprise heating coils 912 and may be filled with cooking liquid 914. The heating coils 912 may heat the cooking liquid 914, which may fry any food placed therein. The mesh filter basket 700 may be placed in the fryer before the cooking liquid is heated or after the cooking liquid is heated. The mesh filter basket 700 may be placed in the fryer before any food is placed in the cooking liquid to retain any food particles when the mesh filter basket 700 is removed from the fryer. The mesh filter basket 700 may comprise a smaller width at the bottom of the basket than the width at the top of the basket as shown in FIG. 9. The difference in width may allow the mesh filter basket 700 to easily fit in the fryer 910 while allowing the top edge of the basket 700 to mate with the top edge of the fryer 910 and retain the basket 700 in position while in use.

FIG. 10 is a general perspective view of an embodiment of a fryer basket 1000 placed inside a fryer 910 comprising the sixth embodiment of a mesh filter basket 700. The fryer basket 1000 may be any fryer basket commonly known in the industry and may comprise wires, bars, or other components of sufficient width to retain the majority of any food placed therein while such food is cooking. The fryer basket 1000 may be filled with food and placed inside the mesh filter basket 700, which may be positioned inside the cooking liquid of the fryer 910. The majority of the food may be removed upon the completion of a cooking cycle by removing the fryer basket 1000. Any food particles that escape the fryer basket 1000 may be filtered from the cooking liquid by removing the filter basket 700 from the fryer 910, which may leave relatively clean cooking liquid in the fryer 910 for further use.

As discussed above, the filter mesh 764 may comprise various ranges of distances between adjacent parallel wires, for example from about 0.0010 inches to about 0.0450 inches, from about 0.0060 to about 0.0350, or from about 0.0060 to about 0.0150 inches. Mesh sizes with distances between adjacent parallel wires of less than about 0.0010 inches may impeded cooking liquid flow which may cause the cooking liquid to drain slowly from the mesh filter baskets disclosed herein, depending on the viscosity of the cooking liquid employed. This may reduce efficiency by increasing the time a fryer must be out of service between cooking cycles. Additionally, mesh sizes with distances between adjacent parallel wires of less than about 0.0010 inches may cause hot cooking liquid to bubble and splatter while draining and/or cooking, which may result in injury. Mesh sizes with distances between adjacent parallel wires of greater than about 0.0450 inches may not sufficiently filter food particles from the cooking liquid, which may reduce the useful life of the cooking liquid.

Users may empty the mesh filter basket 700 of food particles by inverting the basket and hitting the outside of the basket to cause the food particles to fall out of the basket 700 and into a receptacle, such as a trash can. The filter mesh 764 may be delicate due to the small mesh sizes employed in the construction of the filter mesh. Repeated emptying of the mesh filter basket 700 by users, especially users that are in a hurry or unconcerned about equipment durability, may damage the filter mesh 764. Therefore, the structural mesh 762 may be positioned on the outside of the mesh filter basket 700 to protect the filter mesh 764 from damage by users during the draining and emptying procedure. Support members 761 may be posited inside of the basket 700 to prevent fryer basket 1000 from coming into direct contact with the filter mesh 764 during cooking, which may also increase the longevity of the filter mesh 764 by reducing friction and heat related wear and tear thereon.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A mesh filter basket comprising:
a frame; and
a wire mesh attached to the frame,
wherein the mesh filter basket is configured to be placed inside a fryer comprising cooking liquid,
wherein the mesh filter basket is configured to receive a fryer basket comprising food,
wherein the mesh filter basket is configured to allow the cooking liquid to pass through the mesh and cook the food in the fryer basket, and
wherein the mesh filter basket is configured to retain food particles escaping the fryer basket.

2. The mesh filter basket of claim 1, wherein the wire mesh comprises adjacent wires with a distance of about 0.0010 inches to about 0.0450 inches between adjacent wires.

3. The mesh filter basket of claim 1, wherein the wire mesh comprises adjacent wires with a distance of about 0.0060 inches to about 0.0350 inches between adjacent wires.

4. The mesh filter basket of claim 1, wherein the wire mesh comprises adjacent wires with a distance of about 0.0060 inches to about 0.0150 inches between adjacent wires.

5. The mesh filter basket of claim 1 further comprising a structural mesh, wherein the wire mesh is positioned between the structural mesh and the frame, and wherein the structural mesh is configured to protect the wire mesh from damage during use.

6. The mesh filter basket of claim 5, wherein the structural mesh is attached to the frame.

7. The mesh filter basket of claim 6, wherein the wire mesh is positioned inside of the structural mesh.

8. The mesh filter basket of claim 5, wherein the structural mesh comprises adjacent wires with a distance of about 0.5 inches to about 1.5 inches between adjacent wires.

9. The mesh filter basket of claim 5, wherein the structural mesh comprises adjacent wires with a distance of about 0.5 inches to about 1 inch between adjacent wires.

10. The mesh filter basket of claim 5, wherein the structural mesh comprises adjacent wires with a distance of about 1 inch to about 1.5 inches between adjacent wires.

11. The mesh filter basket of claim 5 further comprising support members attached to the frame and positioned inside the wire mesh.

12. The mesh filter basket of claim 11, wherein the support members are configured to prevent the fryer basket from coming into contact with the wire mesh.

13. The mesh filter basket of claim 12, wherein the distance between adjacent parallel support members is about 3 inches.

14. A method comprising:
placing a mesh filter basket into a fryer comprising cooking liquid;
causing the fryer to heat the cooking liquid;
placing a fryer basket comprising uncooked food into the mesh filter basket;
retaining the fryer basket in the mesh filter basket until the food is cooked; and
removing the fryer basket and the cooked food,
wherein the mesh filter basket comprises:
a frame;
a wire mesh attached to the frame;
wherein the mesh filter basket is configured to allow the cooking liquid to enter the mesh filter basket via the wire mesh, and
wherein the mesh filter basket is configured to retain food particles that escape the fryer basket via the wire mesh.

15. The method of claim 14, wherein the wire mesh comprises adjacent wires with a distance of about 0.0010 inch to about 0.0450 inch between adjacent wires.

16. The method of claim 14, wherein the wire mesh comprises adjacent wires with a distance of about 0.0060 inch to about 0.0350 inch between adjacent wires.

17. The method of claim 14, wherein the wire mesh comprises adjacent wires with a distance of about 0.0060 inch to about 0.0150 inches between adjacent wires

18. The method of claim 14 further comprising:
removing the mesh filter basket from the fryer;
removing the retained food particles, and
replacing the mesh filter basket into the fryer and the cooking liquid.

19. The method of claim 14, wherein the mesh filter basket comprises a structural mesh that surrounds and protects the wire mesh from damage.

20. The method of claim 14, wherein the mesh filter basket comprises support members attached to the frame and positioned inside the wire mesh, and wherein the support members are configured to prevent the fryer basket from coming into contact with the wire mesh.

21. An apparatus comprising:
a cooking vessel comprising a concave chamber;
a fryer basket positioned in the concave chamber of the cooking vessel; and
a mesh filter basket positioned between the cooking vessel and the fryer basket,
wherein the mesh filter basket comprises a frame, a structural mesh attached to the frame, and a wire mesh positioned between the frame and the structural mesh.

22. The apparatus of claim 21, wherein the mesh filter basket comprises a top edge, wherein the chamber comprises a top edge, and wherein the top edge of the filter basket mates with the top edge of the chamber.

23. The apparatus of claim 21, wherein fryer basket is configured to receive food particles, and wherein the food particles can escape the fryer basket but not the mesh filter basket.

24. The apparatus of claim 21, wherein the wire mesh comprises adjacent wires with a distance of about 0.0010 inch to about 0.0450 inches between adjacent wires.

25. The apparatus of claim 24, wherein the structural mesh comprises adjacent wires with a distance of about 0.5 inches to about 1.5 inches between adjacent wires.

26. The apparatus of claim 21, wherein the concave chamber comprises a fill line, and wherein a top edge of the wire mesh remains above the fill line.
